(19) United States
(12) Patent Application Publication
(10) Pub. No.: US 2025/0362449 A1
(43) Pub. Date: Nov. 27, 2025

(54) OPTICAL TRANSMISSION CHIP AND CONTROL METHOD THEREOF

(71) Applicant: SILITH TECHNOLOGY (SHANGHAI) CO., LTD., Shanghai (CN)

(72) Inventors: Yuxuan CHEN, Shanghai (CN); Ke ZHANG, Shanghai (CN); Guangzhu ZHOU, Shanghai (CN); Zhexuan ZHENG, Shanghai (CN)

(73) Assignee: SILITH TECHNOLOGY (SHANGHAI) CO., LTD., Shanghai (CN)

(21) Appl. No.: 19/026,623

(22) Filed: Jan. 17, 2025

(30) Foreign Application Priority Data
May 24, 2024 (CN) 202410649395.1

(51) Int. Cl. G02B 6/12; G02B 6/126

(52) U.S. Cl. CPC G02B 6/12004; G02B 6/126; G02B 2006/1204; G02B 2006/12061; G02B 2006/12107; G02B 2006/12111

(57) ABSTRACT

The invention relates to field of optical chips. An optical transmission chip being used for wavefront shaping of multimode transmission optical fibers, includes intensity regulation and control unit, phase regulation and control unit, time delay regulation and control unit and polarization regulation and control unit, which are all integrated on same substrate, and cascaded according to preset sequence. The intensity regulation and control unit is connected with light input unit. The polarization regulation and control unit is connected with light output unit. A number of light output units is N, N is positive integer. Modulation of intensity, phase, time delay and polarization of optical modes is realized by utilizing integrated design method, pre-compensation of optical modes is effectively realized in multimode transmission system, and signal quality of multimode transmission system is improved. The optical chip has advantages of being low in cost, good in stability and high in integration level.

### CROSS-REFERENCE TO RELATED APPLICATION

This application claims the priority benefit of China application serial no. 202410649395.1, filed on May 24, 2024. The entirety of the above-mentioned patent application is hereby incorporated by reference herein and made a part of this specification.

### BACKGROUND

### Technical Field

The present application relates to the technical field of chips, and in particular to an optical transmission chip and a control method thereof.

### Description of Related Art

A multimode fiber supports multiple modes of transmission. It is possible to increase a transmission capacity of a system by simultaneous communication with multiple transverse modes of an optical fiber. When a light is transmitted in different modes in a same optical fiber, different degrees of degradation may occur, and reducing communication quality. It is possible to achieve a pre-compensation to the degradation in a transmission process, by performing a wavefront shaping at a near end of the optical fiber, so as to improve communication quality.

A wavefront regulation in a free light space is relatively complex, and generally requires a spatial light modulator, a digital micromirror device, or a nonlinear crystal, together with a plurality of optical devices in the free light space, such as an objective lens and a lens, occupying a large space, which is difficult to efficiently and accurately adjust an optical parameter, resulting in a pre-compensation effect poor. Therefore, there is an urgent need for a novel optical transmission chip and a control method thereof, so as to improve the problems stated above.

### SUMMARY

The purpose of the present application is providing an optical transmission chip and a control method thereof, wherein the optical transmission chip is configured to improve a pre-compensation effect during a multi-mode transmission of an optical fiber.

On a first aspect, the present application discloses an optical transmission chip, used for wavefront shaping for a multimode transmission optical fiber, comprising: an intensity regulation and control unit, a phase regulation and control unit, a time delay regulation and control unit, and a polarization regulation and control unit integrated on a same substrate; the intensity regulation and control unit, the phase regulation and control unit, the time delay regulation and control unit and the polarization regulation and control unit are cascaded in a preset order; the intensity regulation and control unit is connected to at least one optical input unit; the polarization regulation and control unit is connected to at least one optical output unit; while an amount of the at least one optical output unit is N, and N is a positive integer.

Preferably, the intensity regulation and control unit is configured as an on-chip adjustable light attenuation structure based on a thermo-optic effect.

Preferably, the phase regulation and control unit is configured as an on-chip phase shifter based on the thermo-optic effect.

Preferably, the time delay regulation and control unit is arranged as an on-chip structure based on a Bragg grating (BG) or a combination structure based on an annular resonant cavity array and a Mach-Zehnder interferometer (MZI) optical switch.

Preferably, the polarization regulation and control unit comprises an on-chip directional coupler and a two-dimensional grating.

Preferably, when N is greater than 1, each regulation and control unit is configured to independently regulate and control an output light parameter correspondingly.

Preferably, a material of the substrate comprises at least one of elementary silicon, silicon nitride, and lithium niobite.

Preferably, the preset order for the cascade is set as, following a direction from the optical input unit to the optical output unit, the intensity regulation and control unit, the phase regulation and control unit, the time delay regulation and control unit and the polarization regulation and control unit are cascaded sequentially.

On a second aspect, the present application discloses a control method for an optical transmission chip, configured to control the optical transmission chip according to any one of the first aspect, comprising: S1, obtaining a mode of a target optical fiber, and determining a plurality of coupling parameters according to a current mode; S2, generating an optimization parameter according to the coupling parameter and a degradation parameter of the target optical fiber; and S3, controlling the intensity regulation and control unit, the phase regulation and control unit, the time delay regulation and control unit and the polarization regulation and control unit according to the optimization parameter, when the target optical fiber is coupled to the optical transmission chip, so as to independently regulate and control an optical signal output from each optical output unit.

Preferably, the control method further comprises: detecting a communication quality corresponding to the optical signal transmitted through the target optical fiber; when a variation of the communication quality exceeds a threshold, determining the mode of the target optical fiber has been changed, and re-executing S1 to S3.

The present application has the following beneficial effects: by integrating the intensity regulation and control unit, the phase regulation and control unit, the time delay regulation and control unit and the polarization regulation and control unit onto the same substrate, it is beneficial to reduce an occupied space, increase a product stability and reduce a cost. Meanwhile, it is possible to achieve adjusting intensity, phase, time delay and polarization parameter of the optical signal efficiently and accurately. It is beneficial to improve the pre-compensation effect of the multimode transmission, thus a communication quality is ensured.

### BRIEF DESCRIPTION OF THE DRAWINGS

FIG. 1 illustrates a schematic structural diagram on an optical transmission chip according to the present application.

FIG. 2 illustrates a schematic structural diagram on an intensity regulation and control unit and a phase regulation and control unit according to the present application.

FIG. 3 illustrates a schematic structural diagram on an optical transmission chip having N optical output units arranged according to the present application.

FIG. 4 illustrates a schematic flowchart on a control method of an optical transmission chip according to the present application.

Wherein: 1—optical input unit; 2—intensity regulation and control unit; 22—first waveguide layer; 3—phase regulation and control unit; 31—heating layer; 32—second waveguide layer; 4—time delay regulation and control unit; 5—polarization regulation and control unit; 6—optical output unit; 7—substrate.

### DESCRIPTION OF THE EMBODIMENTS

In order to make the purpose, technical solution and advantages of the present application clearer and more explicit, further detailed descriptions of the present application are stated here, referencing to the attached drawings and some embodiments of the present application. Obviously, the described embodiments are part of, but not all of, the embodiments of the present application. Based on the embodiments of the present application, all other embodiments obtained by those of ordinary skills in the art without any creative work are included in the scope of protection of the present application. Unless otherwise defined, technical or scientific terms used herein should have the meanings usually understood by those of ordinary skills in the art to which the present application belongs. As used herein, the terms “comprise” and the like are intended to mean that an element or item appearing before the term encompasses elements or items appearing after the term and the equivalents thereof, instead of excluding other elements or items.

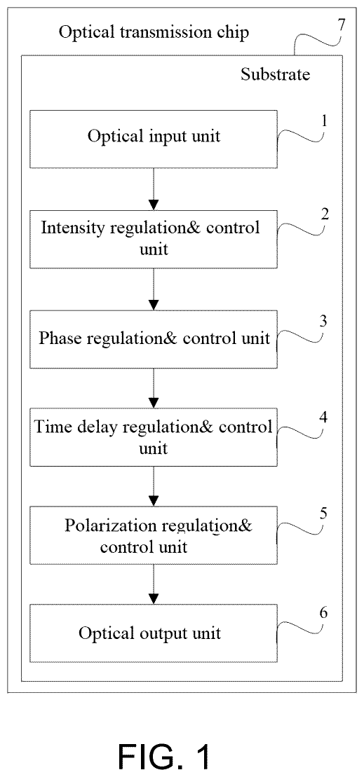

According to the problems in the prior art, shown as FIG. 1, a first embodiment provides an optical transmission chip, used for wavefront shaping for a multimode transmission optical fiber, comprising: an intensity regulation and control unit 2, a phase regulation and control unit 3, a time delay regulation and control unit 4, and a polarization regulation and control unit 5 integrated on a same substrate 7; the intensity regulation and control unit 2, the phase regulation and control unit 3, the time delay regulation and control unit 4 and the polarization regulation and control unit 5 are cascaded in a sequence; the intensity regulation and control unit 2 is connected to at least one optical input unit 1; the polarization regulation and control unit 5 is connected to at least one optical output unit 6; while an amount of the at least one optical output unit 6 is N, and N is a positive integer.

Specifically, the optical input unit 1 is configured as an input-end optical waveguide. The optical output unit 6 is configured as an output-end optical waveguide.

In a plurality of embodiments, the intensity regulation and control unit 2 is configured as an on-chip adjustable light attenuation structure based on a thermo-optic effect.

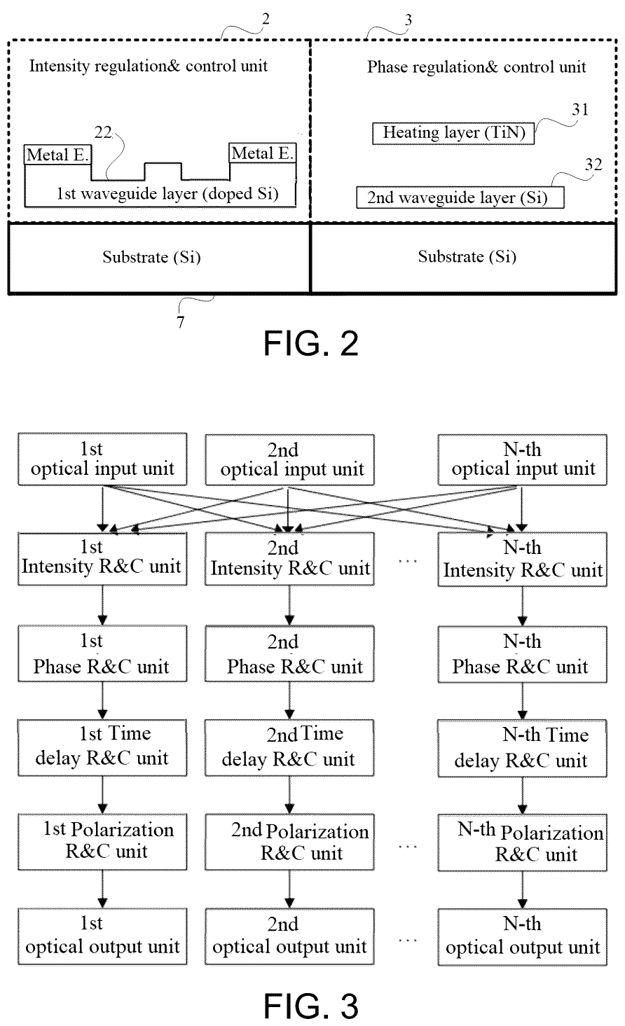

Specifically, shown as FIG. 2, the on-chip adjustable light attenuation structure based on the thermo-optic effect comprises a first waveguide layer 22. The first waveguide layer 22 is configured to conduct an optical signal, and achieve an attenuation of a light intensity.

In an embodiment, a background material of both the intensity regulation and control unit 2 and the phase regulation and control unit 3 is arranged as silicon dioxide (SiO₂). The intensity regulation and control unit 2 comprises a first waveguide layer 22 and a metal electrode, while the first waveguide layer 22 is specifically configured as a doped silicon waveguide. Two metal electrodes are arranged at two ends of the first waveguide layer 22 respectively. The present embodiment is able to achieve regulating and controlling the attenuation degree of the optical signal on chip in real time.

In a plurality of embodiments, the phase regulation and control unit 3 is arranged as an on-chip phase shifter based on the thermo-optic effect. Specifically, the on-chip phase shifter based on the thermo-optic effect comprises a second waveguide layer 32 and a heating layer 31. The second waveguide layer 32 is configured to conduct the optical signal, the heating layer 31 generates heat by controlling a current or a voltage, to change a refractive index of the second waveguide layer 32, further change a phase of light in the second waveguide layer 32. Specifically, the heating layer 31 is arranged as Titanium Nitride (TiN). In an embodiment, the second waveguide layer 32 is arranged as silicon (Si), and the heating layer 31 is arranged as Titanium Nitride. The present embodiment is able to achieve regulating and controlling the phase of the optical signal on chip in real time.

In a plurality of embodiments, the time delay regulation and control unit 4 is arranged as an on-chip structure based on a Bragg grating (BG). In a plurality of other embodiments, the time delay regulation and control unit 4 is arranged as a combination structure based on an annular resonant cavity array and a Mach-Zehnder interferometer (MZI) optical switch.

In a plurality of embodiments, the polarization regulation and control unit 5 comprises an on-chip directional coupler and a two-dimensional grating. Specifically, the on-chip directional coupler is arranged facing to the time delay regulation and control unit 4.

In a plurality of other specific embodiments, the polarization regulation and control unit 5 may adopt a micro-nano optical element integrated on an photonic chip, such as an artificial material metasurface. The present embodiment is able to achieve an extremely high accuracy and flexibility of the polarization regulation and control, and adapted to a plurality of requirements on a modern high-speed optical communication system and a precision optical measurement device.

Shown as FIG. 3, in a plurality of embodiments, when N is greater than 1, each regulation unit is configured to independently regulate and control an output light parameter correspondingly. An amount of all the light output unit 6, the intensity regulation and control unit 2, the phase regulation and control unit 3, the time delay regulation and control unit 4 and the polarization regulation and control unit 5 is N.

In another embodiment, the intensity regulation and control unit 2, the phase regulation and control unit 3, the time delay regulation and control unit 4 and the polarization regulation and control unit 5 do not have to be started at a same time, following a cascade direction from light input to light output, it only requires that an amount of the regulation and control units being started in a previous-stage is less than or equal to an amount of the regulation and control units being started in a following stage.

In a plurality of embodiments, a material of the substrate 7 comprises at least one of silicon or lithium niobate. In an embodiment, the material of the substrate 7 is silicon. In another embodiment, the material of the substrate 7 is lithium niobate. In one more embodiment, the material of the substrate 7 is a composite material of silicon and lithium niobate.

The optical transmission chip in the embodiments of the present application achieves a modulation to multiple optical modes in four dimensions including intensity, phase, time delay, and polarization, by using an integrated design method. The optical transmission chip is able to achieve a pre-compensation of the optical mode effectively in the multimode transmission system, and improve a signal quality of the multimode transmission system. Compared with a conventional compensation method for a free optical space device, the optical transmission chip has a plurality of advantages including low cost, good stability, high integration level, and convenience for productization.

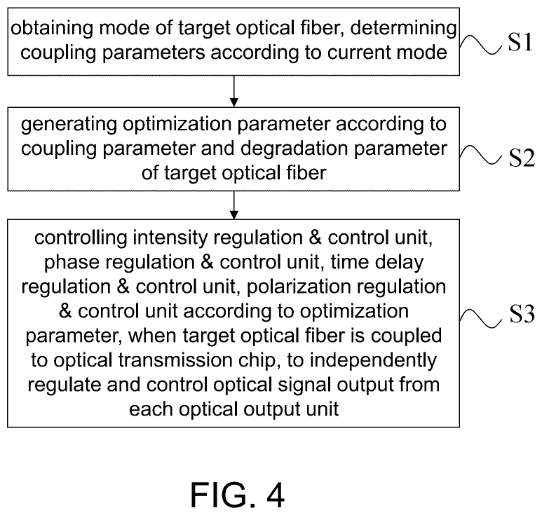

Shown as FIG. 4, a second embodiment provides a control method for an optical transmission chip, configured to control the optical transmission chip according to any one of the first aspect, comprising: S1, obtaining a mode of a target optical fiber, and determining a plurality of coupling parameters according to a current mode; S2, generating an optimization parameter according to the coupling parameter and a degradation parameter of the target optical fiber; and S3, controlling the intensity regulation and control unit, the phase regulation and control unit, the time delay regulation and control unit and the polarization regulation and control unit according to the optimization parameter, when the target optical fiber is coupled to the optical transmission chip, so as to independently regulate and control an optical signal output from each optical output unit.

In an embodiment, after a model of the optical fiber used in the optical transmission system has been determined, a physical size thereof is determined, and an optical mode distribution field being supported is also determined accordingly. Thus the optical mode distribution field of the optical chip required to be supported/transmitted is also determined. The optical input unit and the optical output unit of the optical transmission chip shall have a maximum mode coupling with a plurality of light fields stated above, so as to reduce a loss in a transmission system. According to a distribution of a target light field, it is possible to adjust the amount, a distribution and a size of the optical input unit and the optical output unit of the optical transmission chip, before being denoted as a plurality of coupling parameters.

In a plurality of other specific embodiments, determining the plurality of coupling parameters according to the current mode, comprises determining a plurality of optimal coupling parameters by using an algorithm and/or a preset rule according to the current mode of the target fiber. The parameters comprise, but not limited to, an amount of the optical mode, a beam waist, a divergence angle of each mode, an angle and a geometry of an end-face of the optical fiber.

In an actual optical transmission scenario, due to an optical mode degradation happened in each step in the transmission system, the quality of a finally received optical mode will be lower than a theoretical optimal situation. The degradation comprises a plurality of dimensions, including intensity, phase, time delay, and polarization. By means of a plurality of modulation units in the optical chip, the degradation in the dimensions stated above can be effectively compensated, further the quality of the optical mode being finally received will be optimized. By defining an optical mode quality factor (a light intensity or a bit error rate), and optimizing the optical mode quality factor through the intensity, the phase, the time delay and a modulation signal of a polarization modulation unit, a plurality of optical parameters will be achieved.

In a plurality of more specific embodiments, generating the plurality of optimization parameters based on the coupling parameter and the degradation parameter of the target optical fiber, comprises generating a set of optimization parameters based on a determined coupling parameter and the degradation parameter of the target optical fiber (including bending, stretching, and temperature changing of the optical fiber). The optimization parameters will be applied to controlling each regulation and control unit in the optical transmission chip, so as to ensure an optimal transmission effect of an optical signal.

It is noted that, when the target optical fiber is coupled with the optical transmission chip, by combining the coupling parameter and the optimization parameter, it is possible to obtain an optimal optical chip and a setting method thereof to modulate a signal, which is denoted as a group of the optimization parameters. By controlling each control unit in the optical transmission chip according to the optimization parameters, the optical mode quality at the receiving end can be optimal.

In a plurality of embodiments, the control method further comprises: detecting a communication quality corresponding to the optical signal transmitted through the target optical fiber; and when a variation of the communication quality exceeds a threshold, determining the mode of the target optical fiber has been changed, so re-executing S1 to S3.

Specifically, the communication quality corresponding to the optical signal transmitted through the target optical fiber is detected. After the optical signal is transmitted through the target optical fiber, the communication quality, such as a strength and a bit error rate of the signal, is detected by an optical power meter or an error code instrument.

In a plurality of other specific embodiments, when a detected communication quality variation has exceeded a preset threshold, it means that an optimal compensation parameter in the current system may have been changed, and a fiber mode shall be re-acquired and the coupling parameter shall be adjusted. In this way, it can be ensured that the optical signal always maintains a good communication quality.

In a plurality of more specific embodiments, during a transmission process of the optical signal, according to a communication quality monitored in real time, the intensity regulation and control unit, the phase regulation and control unit, the delay regulation and control unit and the polarization regulation and control unit may be dynamically adjusted, to further optimize the communication quality. Such a dynamic adjustment is able to quickly respond to a change of the optical fiber mode in a short time, thereby improve the stability of the optical signal transmission. According to the embodiments stated above, the control method for the optical transmission chip disclosed in the present application can dynamically adjust the output parameters of the optical signal according to the mode change of the target optical fiber, thereby ensuring a stable communication quality.

Through the description of the foregoing implementations, a person skilled in the art may clearly understand that, for the purpose of convenient and brief description, the division of the foregoing functional modules is used only for illustration, and in actual application, the function allocation may be completed by different functional modules according to needs, that is, the internal structure of the apparatus is divided into different functional modules to complete all or some of the functions described above. For a specific working process of the foregoing system, apparatus, and unit, reference may be made to a corresponding process in the foregoing method embodiments, and details are not described herein again.

While the embodiments of the present application have been described in detail above, it will be apparent to those skilled in the art that various modifications and variations can be made to the embodiments. It should be understood, however, that such modifications and variations are within the scope and spirit of the present application as set forth in the claims. Moreover, the present application described herein is capable of other embodiments and of being practiced or of being carried out in various ways.

What is claimed is:

1. An optical transmission chip, used for wavefront shaping for a multimode transmission optical fiber, comprising: an intensity regulation and control unit, a phase regulation and control unit, a time delay regulation and control unit, and a polarization regulation and control unit, which are all integrated on a same substrate,
wherein the intensity regulation and control unit, the phase regulation and control unit, the time delay regulation and control unit and the polarization regulation and control unit are cascaded in a preset order,
wherein the time delay regulation and control unit is arranged as an on-chip structure based on a Bragg grating or a combination structure based on an annular resonant cavity array and a Mach-Zehnder interferometer optical switch,
wherein the intensity regulation and control unit is connected to at least one optical input unit,
wherein the polarization regulation and control unit is connected to at least one optical output unit,
wherein the intensity regulation and control unit is configured as an on-chip adjustable light attenuation structure based on a thermo-optic effect,
wherein an amount of the at least one optical output unit is N, and N is a positive integer.

2. The optical transmission chip according to claim 1, wherein the phase regulation and control unit is configured as an on-chip phase shifter based on the thermo-optic effect.

3. The optical transmission chip according to claim 1, wherein the polarization regulation and control unit comprises an on-chip directional coupler and a two-dimensional grating.

4. The optical transmission chip according to claim 1, wherein when N is greater than 1, each regulation and control unit is configured to independently regulate and control an output light parameter correspondingly.

5. The optical transmission chip according to claim 1, wherein a material of the substrate comprises at least one of elementary silicon, silicon nitride, and lithium niobate.

6. The optical transmission chip according to claim 1, wherein the preset order for the cascade is arranged as, following a direction from the optical input unit to the optical output unit, the intensity regulation and control unit, the phase regulation and control unit, the time delay regulation and control unit and the polarization regulation and control unit are cascaded sequentially.

7. A control method for an optical transmission chip, configured to control the optical transmission chip according to claim 1, wherein comprising:
S1, obtaining a mode of a target optical fiber, and determining a plurality of coupling parameters according to a current mode;
S2, generating an optimization parameter according to the coupling parameter and a degradation parameter of the target optical fiber; and
S3, controlling the intensity regulation and control unit, the phase regulation and control unit, the time delay regulation and control unit and the polarization regulation and control unit according to the optimization parameter, when the target optical fiber is coupled to the optical transmission chip, so as to independently regulate and control an optical signal output from each optical output unit.

8. The control method according to claim 7, wherein the phase regulation and control unit is configured as an on-chip phase shifter based on the thermo-optic effect.

9. The control method according to claim 7, wherein the polarization regulation and control unit comprises an on-chip directional coupler and a two-dimensional grating.

10. The control method according to claim 7, wherein when N is greater than 1, each regulation and control unit is configured to independently regulate and control an output light parameter correspondingly.

11. The control method according to claim 7, wherein a material of the substrate comprises at least one of elementary silicon, silicon nitride, and lithium niobate.

12. The control method according to claim 7, wherein the preset order for the cascade is arranged as, following a direction from the optical input unit to the optical output unit, the intensity regulation and control unit, the phase regulation and control unit, the time delay regulation and control unit and the polarization regulation and control unit are cascaded sequentially.

13. The control method according to claim 7, wherein the control method further comprises: detecting a communication quality corresponding to the optical signal transmitted through the target optical fiber; when a variation of the communication quality exceeds a threshold, determining the mode of the target optical fiber has been changed, and re-executing S1 to S3.

14. The control method according to claim 8, wherein the control method further comprises: detecting a communication quality corresponding to the optical signal transmitted through the target optical fiber; when a variation of the communication quality exceeds a threshold, determining the mode of the target optical fiber has been changed, and re-executing S1 to S3.

15. The control method according to claim 9, wherein the control method further comprises: detecting a communication quality corresponding to the optical signal transmitted through the target optical fiber; when a variation of the communication quality exceeds a threshold, determining the mode of the target optical fiber has been changed, and re-executing S1 to S3.
